(19) United States
(12) Patent Application Publication
(10) Pub. No.: US 2025/0023301 A1
(43) Pub. Date: Jan. 16, 2025

(54) BACKPLANE CONNECTOR WITH IMPROVED METAL SHIELD SURROUNDING MEMBER

(71) Applicant: DONGGUAN LUXSHARE TECHNOLOGIES CO., LTD, Dongguan City (CN)

(72) Inventors: Tao SONG, Dongguan City (CN); Kun LIU, Dongguan City (CN); Xiaoping WU, Dongguan City (CN)

(73) Assignee: DONGGUAN LUXSHARE TECHNOLOGIES CO., LTD, Dongguan City (CN)

(21) Appl. No.: 18/901,538

(22) Filed: Sep. 30, 2024

Related U.S. Application Data
(63) Continuation-in-part of application No. 18/231,987, filed on Aug. 9, 2023.
Application No. 18/231,987 is a continuation-in-part of application No. 17/341,129, filed on Jun. 7, 2021, now Pat. No. 11,769,968.

(30) Foreign Application Priority Data
Jun. 19, 2020 (CN) 202010567796.4
Aug. 17, 2020 (CN) 202021709484.4
Jun. 25, 2024 (CN) 202421467374.X

(51) Int. Cl. H01R 13/6587; H01R 12/73

(52) U.S. Cl. CPC H01R 13/6587; H01R 12/737

(57) ABSTRACT

A backplane connector includes a housing, an insulating body, a terminal module and a metal shield surrounding member. The housing includes a base, a first side wall, a second side wall and a receiving space. The metal shield surrounding member is sleeved on the insulating body. The metal shield surrounding member includes a surrounding portion protruding into the receiving space. The surrounding portion defines an inner cavity. The surrounding portion includes a port portion and a reflective piece bent from the port portion. The reflective piece extends at least partially into the inner cavity and is configured to adjust impedance of a signal terminal to a certain extent.

### CROSS-REFERENCE TO RELATED APPLICATIONS

This patent application claims priority of a Chinese Patent Application No. 202421467374.X, filed on Jun. 25, 2024 and titled “BACKPLANE CONNECTOR”, and is a continuation-in-part of U.S. patent application Ser. No. 18/231,987, filed on Aug. 9, 2023, which is a continuation-in-part of U.S. patent application Ser. No. 17/341,129, filed on Jun. 7, 2021, which claims priority of both a Chinese Patent Application No. 202010567796.4, filed on Jun. 19, 2020 and titled “BACKPLANE CONNECTOR ASSEMBLY”, and a Chinese Patent Application No. 202021709484.4, filed on Aug. 17, 2020 and titled “BACKPLANE CONNECTOR”, the entire content of which is incorporated herein by reference.

### TECHNICAL FIELD

The present disclosure relates to a backplane connector which belongs to a technical field of connectors.

### BACKGROUND

Existing backplane connectors generally include a housing and a plurality of terminal modules mounted to the housing. Each terminal module includes an insulating block, a plurality of conductive terminals fixed to the insulating block, and a metal shield surrounding member provided on a periphery of the insulating block. Each conductive terminal includes a contact portion for mating with a mating backplane connector and a mounting portion for being connected with a circuit board. In order to keep the mounting portions of the terminal modules in a positional relationship with each other so as to be mounted to the circuit board, some existing backplane connectors are further provided with a mounting block installed at a bottom of the terminal modules. The mounting block is usually made of insulating material, and defines a plurality of mounting holes for the mounting portions of the conductive terminals to pass through.

A metal shield surrounding member in the related art includes a surrounding portion and a mounting portion extending downwardly from the surrounding portion. The surrounding portion includes a first side wall, a second side wall opposite to the first side wall, a third side wall connecting one end of the first side wall and one end of the second side wall, and a fourth side wall connecting the other end of the first side wall and the other end of the second side wall.

In the process of the backplane connector and the mating connector moving from a mating state to a separation state, as the signal terminals of the backplane connector are separated from the signal terminals of the mating connector, the impedance of the signal terminals will change.

Therefore, it is desirable to improve the metal shield surrounding member in the related art so as to improve the impedance to the signal terminals.

### SUMMARY

An object of the present disclosure is to provide a metal shield surrounding member and a backplane connector that are beneficial to adjust impedance of signal terminals.

In order to achieve the above object, the present disclosure adopts the following technical solution: a backplane connector, including: a housing including a base, a first side wall portion extending from one end of the base, and a second side wall portion extending from another end of the base; the base, the first side wall portion and the second side wall portion jointly forming a receiving space for at least partially receiving a mating connector; an insulating body, the insulating body defining at least one terminal receiving hole; a terminal module, the terminal module including a first signal terminal and a second signal terminal; the first signal terminal and the second signal terminal being at least partially disposed in the at least one terminal receiving hole; and a metal shield surrounding member, the metal shield surrounding member being sleeved on the insulating body; wherein the metal shield surrounding member includes a surrounding portion protruding into the receiving space; the surrounding portion includes a first side wall, a second side wall, a third side wall and a fourth side wall; the first side wall is disposed opposite to the third side wall; the second side wall is disposed opposite to the fourth side wall; the first side wall, the second side wall, the third side wall and the fourth side wall are enclosed to form an inner cavity; and wherein the surrounding portion includes a port portion and at least one reflective piece which is bent from the port portion; the at least one reflective piece extends at least partially into the inner cavity along a first direction.

Compared with the prior art, the surrounding portion of the metal shield surrounding member of the present disclosure includes the port portion and at least one reflective piece bent from the port portion into the inner cavity. The reflective piece extends at least partially into the inner cavity along the first direction. The reflective piece is configured to adjust the impedance of the signal terminals to a certain extent, so that when the first backplane connector and the second backplane connector change from a mating state to a separation state, the impedance change of the signal terminals is suppressed as much as possible, so that the impedance of the signal terminals can be kept stable.

### BRIEF DESCRIPTION OF DRAWINGS

FIG. 1 is a schematic perspective view of a backplane connector assembly in accordance with a first embodiment of the present disclosure;

FIG. 2 is a partially exploded perspective view of FIG. 1;

FIG. 3 is another view of a second backplane connector in FIG. 2 when it is installed on a second circuit board;

FIG. 4 is an exploded perspective view of the second backplane connector and the second circuit board in FIG. 3;

FIG. 5 is a front view of the second backplane connector in FIG. 3;

FIG. 6 is a rear view of FIG. 5;

FIG. 7 is a top view of FIG. 5;

FIG. 8 is a partial enlarged view of a frame portion A in FIG. 7;

FIG. 9 is a bottom view of FIG. 5;

FIG. 10 is a partially exploded perspective view of the second backplane connector in FIG. 4;

FIG. 11 is a partially exploded perspective view of FIG. 10 from another angle;

FIG. 12 is a partial enlarged view of a circled portion B in FIG. 10;

FIG. 13 is a partial enlarged view of a circled portion C in FIG. 11;

FIG. 14 is a partially exploded perspective view of a terminal module in FIG. 10;

FIG. 15 is a partially exploded perspective view of FIG. 14 from another angle;

FIG. 16 is an exploded perspective view of an insulating body and terminal module in FIG. 14;

FIG. 17 is an exploded perspective view of FIG. 16 from another angle;

FIG. 18 is an exploded perspective view of FIG. 17 from another angle;

FIG. 19 is a front view of the terminal module in FIG. 16;

FIG. 20 is a rear view of FIG. 19;

FIG. 21 is a schematic cross-sectional view taken along line D-D in FIG. 3;

FIG. 22 is a partial enlarged view of a frame portion E in FIG. 21;

FIG. 23 is a schematic perspective view of the second backplane connector in accordance with a second embodiment of the present disclosure when it is installed on the second circuit board;

FIG. 24 is a partially exploded perspective view of FIG. 23;

FIG. 25 is a partially exploded perspective view of FIG. 24 from another angle;

FIG. 26 is a further perspective exploded view of the second backplane connector in FIG. 24;

FIG. 27 is an exploded perspective view of FIG. 26 from another angle;

FIG. 28 is a perspective view of a metal shield surrounding member in FIG. 26;

FIG. 29 is a perspective view of the metal shield surrounding member in FIG. 27;

FIG. 30 is a perspective view of FIG. 29 from another angle;

FIG. 31 is a cross-sectional perspective view taken along line F-F in FIG. 28;

FIG. 32 is a cross-sectional perspective view taken along line H-H in FIG. 28;

FIG. 33 is a left view of FIG. 31;

FIG. 34 is a left view of FIG. 32;

FIG. 35 is a schematic cross-sectional view taken along line I-I in FIG. 23; and

FIG. 36 is a partial enlarged view of a frame portion J in FIG. 35.

### DETAILED DESCRIPTION

Exemplary embodiments will be described in detail here, examples of which are shown in drawings. When referring to the drawings below, unless otherwise indicated, same numerals in different drawings represent the same or similar elements. The examples described in the following exemplary embodiments do not represent all embodiments consistent with this application. Rather, they are merely examples of devices and methods consistent with some aspects of the application as detailed in the appended claims.

The terminology used in this application is only for the purpose of describing particular embodiments, and is not intended to limit this application. The singular forms “a”, “said”, and “the” used in this application and the appended claims are also intended to include plural forms unless the context clearly indicates other meanings.

It should be understood that the terms “first”, “second” and similar words used in the specification and claims of this application do not represent any order, quantity or importance, but are only used to distinguish different components. Similarly, “an” or “a” and other similar words do not mean a quantity limit, but mean that there is at least one; “multiple” or “a plurality of” means two or more than two. Unless otherwise noted, “front”, “rear”, “lower” and/or “upper” and similar words are for ease of description only and are not limited to one location or one spatial orientation. Similar words such as “include” or “comprise” mean that elements or objects appear before “include” or “comprise” cover elements or objects listed after “include” or “comprise” and their equivalents, and do not exclude other elements or objects. The term “a plurality of” mentioned in the present disclosure includes two or more.

Hereinafter, some embodiments of the present disclosure will be described in detail with reference to the accompanying drawings. In the case of no conflict, the following embodiments and features in the embodiments can be combined with each other.

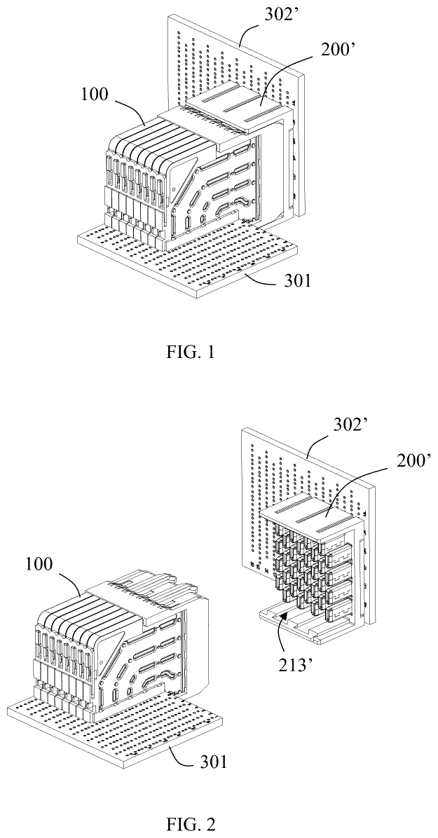

Referring to FIGS. 1 and 2, a first embodiment of the present disclosure discloses a backplane connector assembly which includes a first backplane connector 100, a second backplane connector 200′ for mating with the first backplane connector 100, a first circuit board 301 mounted with the first backplane connector 100, and a second circuit board 302′ mounted with the second backplane connector 200′. In the illustrated first embodiment of the present disclosure, the first backplane connector 100 and the second backplane connector 200′ are mated in an orthogonal manner. The first circuit board 301 is perpendicular to the second circuit board 302′.

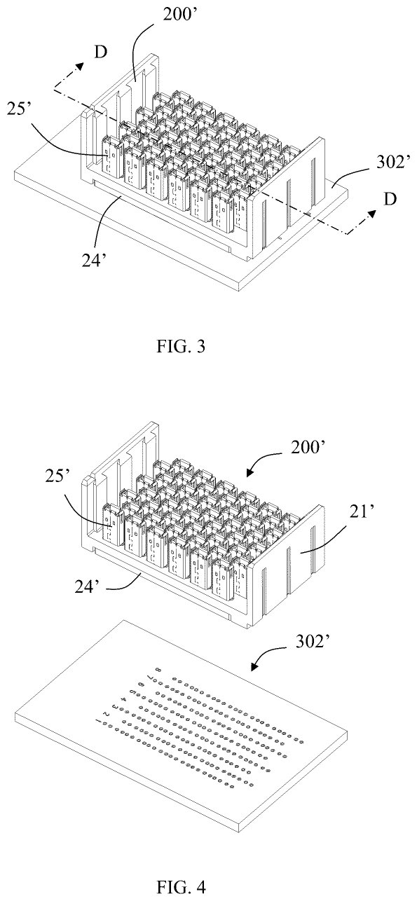

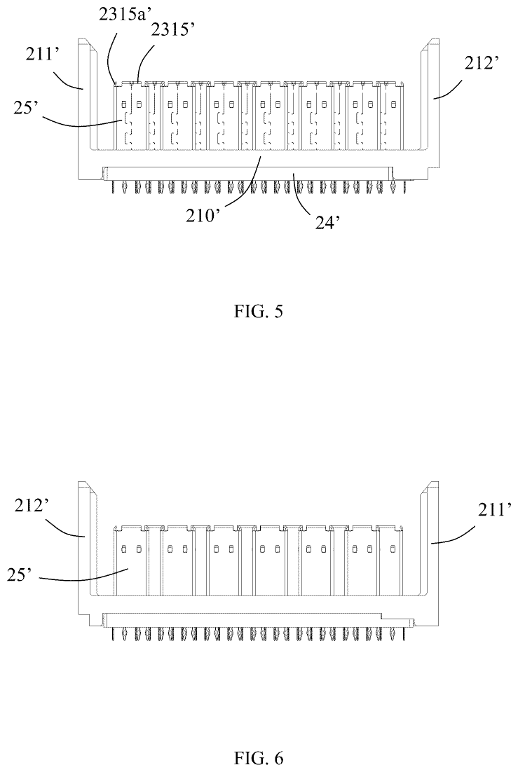

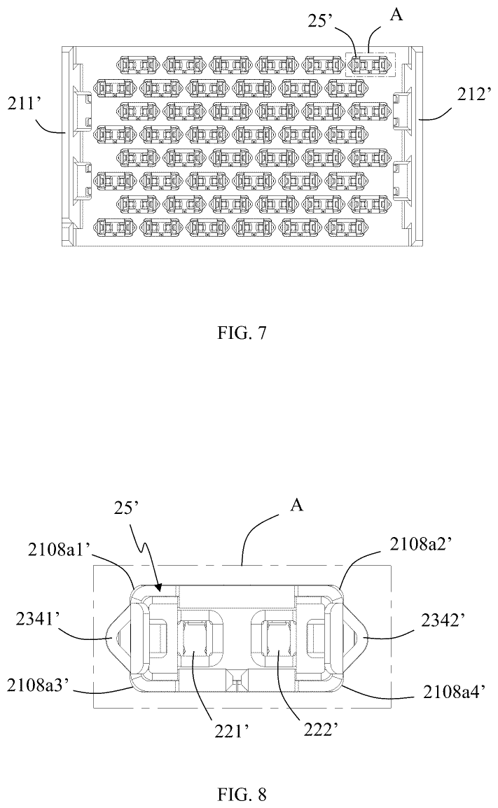

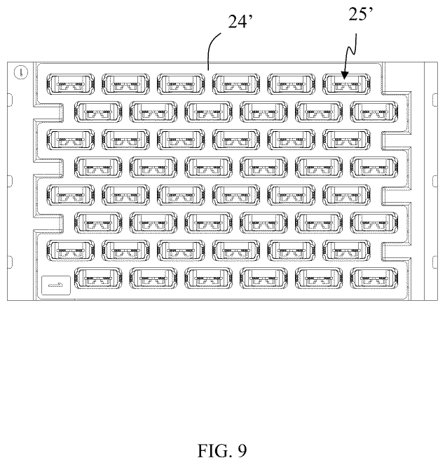

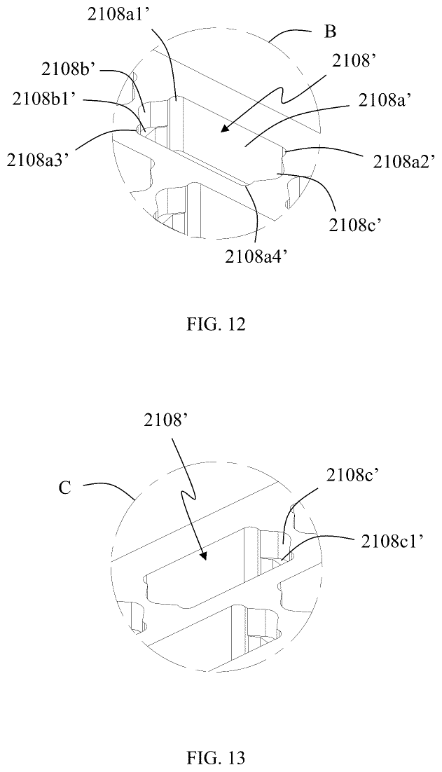

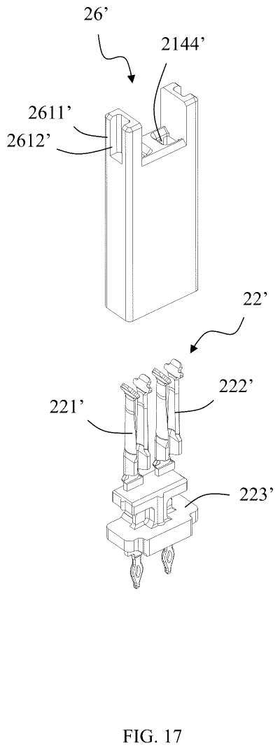

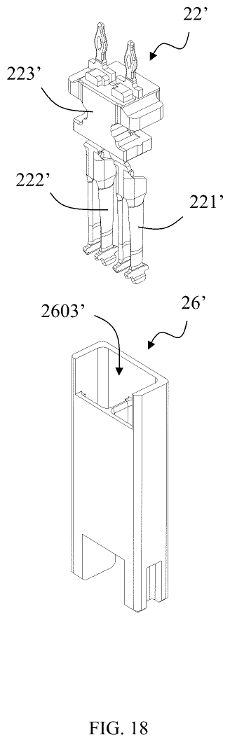

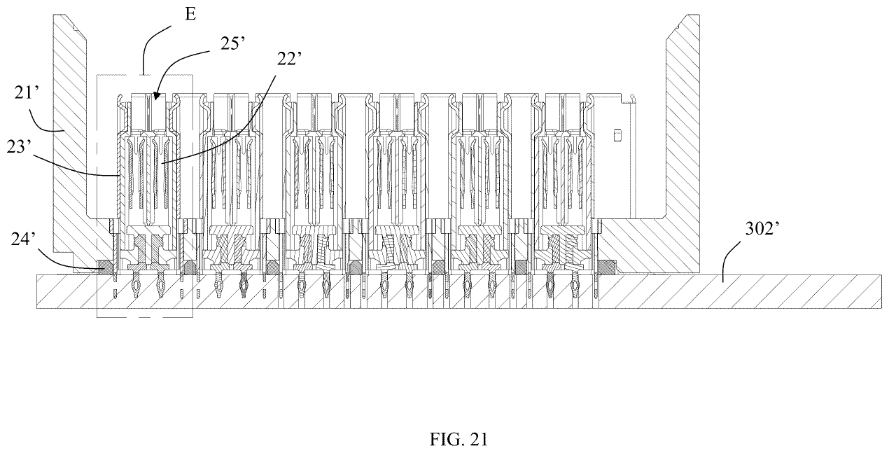

Referring to FIGS. 3 to 22, in the first embodiment of the present disclosure, the second backplane connector 200′ includes a housing 21′, a plurality of mounting modules 25′ mounted to the housing 21′, and a mounting block 24′ mounted to the housing 21′. Each mounting module 25′ includes an insulating body 26′, a terminal module 22′ installed in the insulating body 26′, and a metal shield surrounding member 23′ sleeved on the insulating body 26′.

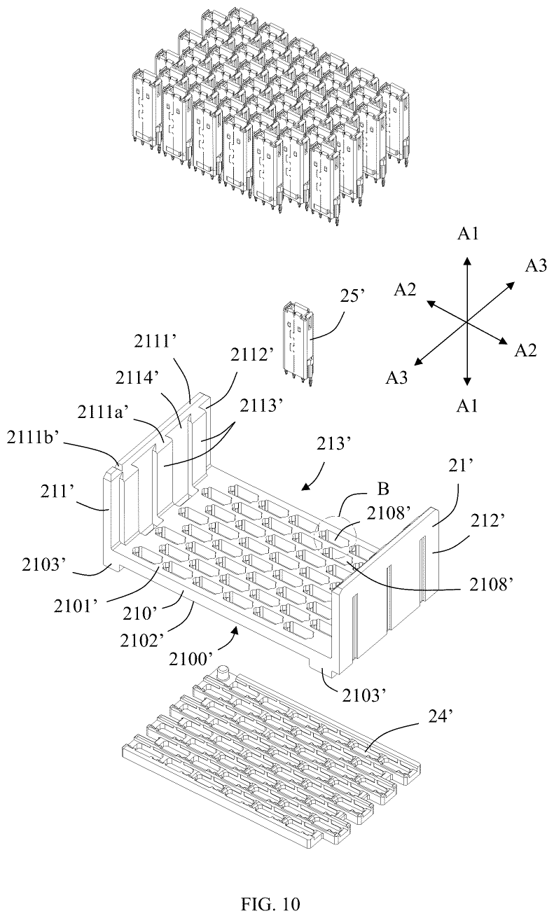

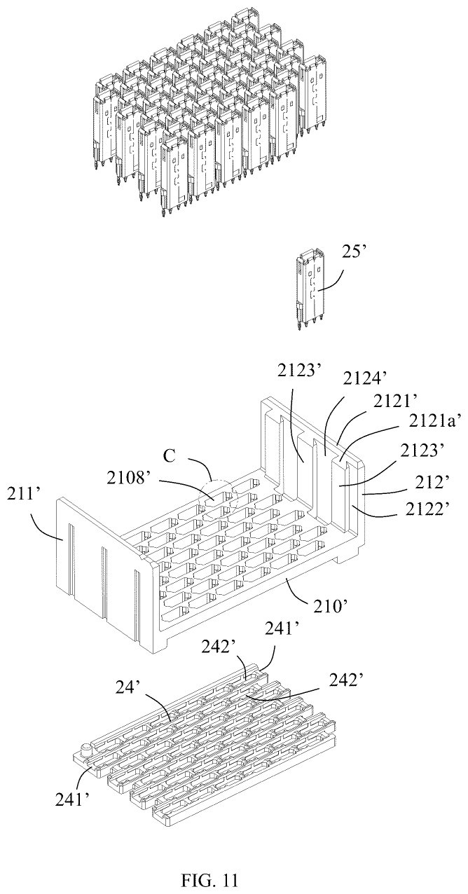

Referring to FIG. 10 and FIG. 11, the housing 21′ is made of insulating material and includes a base 210′, a first side wall portion 211′ extending upwardly from one side of the base 210′, and a second side wall portion 212′ extending upwardly from the other side of the base 210′.

The base 210′, the first side wall portion 211′ and the second side wall portion 212′ jointly form a receiving space 213′ for receiving a part of the first backplane connector 100. In the illustrated first embodiment of the present disclosure, the first side wall portion 211′ and the second side wall portion 212′ are parallel to each other and both are perpendicular to the base 210′.

In the illustrated first embodiment of the present disclosure, the base 210′ includes a top surface 2101′ exposed in the receiving space 213′, a bottom surface 2102′ opposite to the top surface 2101′, two mounting protrusions 2103′ respectively protruding downwardly from opposite sides of the bottom surface 2102′, and a receiving groove 2100′ located between the two mounting protrusions 2103′. The receiving groove 2100′ is adapted for receiving the mounting block 24′.

As shown in FIG. 10 to FIG. 13, the base 210′ further includes a plurality of receiving grooves 2108′ extending through the top surface 2101′ and the bottom surface 2102′. The plurality of receiving grooves 2108′ are arranged in multiple rows along a third direction A3-A3 (for example, a front-rear direction). The receiving grooves 2108′ in two adjacent rows are staggered. That is, the receiving grooves 2108′ at a corresponding position in two adjacent rows are not aligned along the third direction A3-A3. In the illustrated first embodiment of the present disclosure, each receiving groove 2108′ includes a main groove 2108a′ in the middle, a first groove 2108b′ located on one side of the main groove 2108a′, and a second groove 2108c′ located on the other side of the main groove 2108a′. In the illustrated first embodiment of the present disclosure, the first groove 2108b′ is an arc-shaped groove which is recessed in a direction away from the second groove 2108c′. The second groove 2108c′ is an arc groove which is recessed in a direction away from the first groove 2108b′. The main groove 2108a′ includes a first arc-shaped surface 2108a1′, a second arc-shaped surface 2108a2′, a third arc-shaped surface 2108a3′ and a fourth arc-shaped surface 2108a4′ which are located at four corners thereof. The first groove 2108b′ is located in the middle of the first arc-shaped surface 2108a1′ and the third arc-shaped surface 2108a3′; and the second groove 2108c′ is located in the middle of the second arc-shaped surface 2108a2′ and the fourth arc-shaped surface 2108a4′, so as to maintain the symmetry of the receiving groove 2108′. In the illustrated first embodiment of the present disclosure, both the first groove 2108b′ and the second groove 2108c′ extend upwardly through the top surface 2101′. However, neither the first groove 2108b′ nor the second groove 2108c′ extends downwardly through the bottom surface 2102′. The base 210′ includes a first support surface 2108b1′ at a bottom of the first groove 2108b′ and a second support surface 2108c1′ located at a bottom of the second groove 2108c′.

Referring to FIG. 10, the first side wall portion 211′ includes a first top surface 2111′, a first inner side surface 2112′, a plurality of first protrusions 2113′ protruding inwardly from the first inner side surface 2112′ into the receiving space 213′, and a plurality of first positioning groove 2114′ each of which is located between two adjacent first protrusions 2113′. In the illustrated first embodiment of the present disclosure, the first positioning groove 2114′ is a dovetail groove. The first positioning groove 2114′ has two oppositely arranged inclined surfaces, thereby making the width of the first positioning groove 2114′ close to the first inner side surface 2112′ be larger than the width of the first positioning groove 2114′ away from the first inner side surface 2112′. In addition, the first top surface 2111′ has a first guiding inclined surface 2111a′ inclined toward the receiving space 213′ and a notch 2111b′ extending upwardly through the first top surface 2111′. The notch 2111b′ can serve an identification function to prevent the first backplane connector 100 from being inserted at a wrong angle. The first guiding inclined surface 2111a′ further extends to the top of the plurality of first protrusions 2113′.

Referring to FIG. 11, the second side wall portion 212′ includes a second top surface 2121′, a second inner side surface 2122′, a plurality of second protrusions 2123′ protruding inwardly from the second inner side surface 2122′ into the receiving space 213′, and a plurality of second positioning grooves 2124′ each of which is located between two adjacent second protrusions 2123′. In the illustrated first embodiment of the present disclosure, the second positioning groove 2124′ is a dovetail groove. The second positioning groove 2124′ has two opposite inclined surfaces, thereby making the width of the second positioning groove 2124′ close to the second inner side surface 2122′ be larger than the width of the second positioning groove 2124′ away from the second inner side surface 2122′. In addition, the second top surface 2121′ has a second guiding inclined surface 2121a′ which is inclined toward the receiving space 213′. The second guiding inclined surface 2121a′ further extends to the top of the plurality of second protrusions 2123′. The first guiding inclined surface 2111a′ and the second guiding inclined surface 2121a′ are used to guide the first backplane connector 100 to be inserted into the receiving space 213′. In the illustrated first embodiment of the present disclosure, the first protrusions 2113′ and the second protrusions 2123′ are symmetrically disposed on opposite sides of the housing 21′. The first positioning grooves 2114′ and the second positioning grooves 2124′ are also symmetrically disposed on opposite sides of the housing 21′.

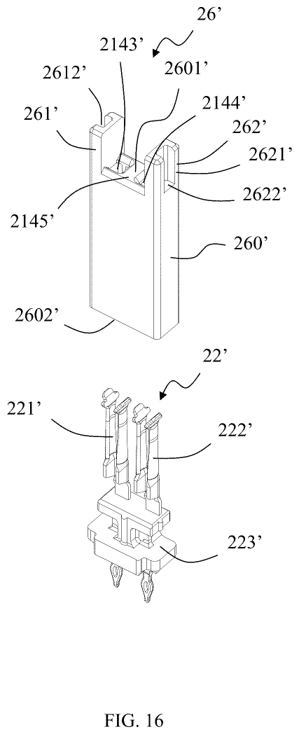

Referring to FIG. 16 to FIG. 18, the insulating body 26′ includes a base portion 260′, a first extension block 261′ extending upwardly from one side of the base portion 260′, and a second extension block 262′ extending upwardly from the other side of the base portion 260′. The base portion 260′ includes an upper surface 2601′, a lower surface 2602′, at least one terminal receiving hole extending upwardly through the upper surface 2601′, and an accommodating space 2603′ extending downwardly through the lower surface 2602′. Both the first extension block 261′ and the second extension block 262′ extend upwardly beyond the upper surface 2601′. The insulating body 26′ further includes an accommodating space 263′ located between the first extension block 261′ and the second extension block 262′. In the illustrated first embodiment of the present disclosure, the at least one terminal receiving hole includes a first terminal receiving hole 2143′ and a second terminal receiving hole 2144′ arranged in parallel. Both the first terminal receiving hole 2143′ and the second terminal receiving hole 2144′ are square holes. The base portion 260′ is further provided with a partition portion 2145′ for separating the first terminal receiving hole 2143′ from the second terminal receiving hole 2144′.

In the illustrated first embodiment of the present disclosure, both the first extension block 261′ and the second extension block 262′ are integrally formed with the base portion 260′. The first extension block 261′ includes an outer first side surface 2611′ and a first positioning groove 2612′ recessed inwardly from the first side surface 2611′. The second extension block 262′ includes an outer second side surface 2621′ and a second positioning groove 2622′ recessed inwardly from the second side surface 2621′. In the illustrated first embodiment of the present disclosure, the first positioning groove 2612′ extends upwardly through the top surface of the first extension block 261′. The second positioning groove 2622′ extends upwardly through the top surface of the second extension block 262′. In the illustrated first embodiment of the present disclosure, the first positioning groove 2612′ does not extend inwardly through the first extension block 261′. The second positioning groove 2622′ does not extend inwardly through the second extension block 262′. As a result, on the one hand, such design helps to improve the structural strength of the insulating body 26′; on the other hand, it prevents the metal shield surrounding member 23′ from extending from the first positioning groove 2612′ and the second positioning groove 2622′ into a space between the first extension block 261′ and the second extension block 262′, thereby reducing the risk of short circuit caused by the metal shield surrounding member 23′ being in contact with the signal terminals.

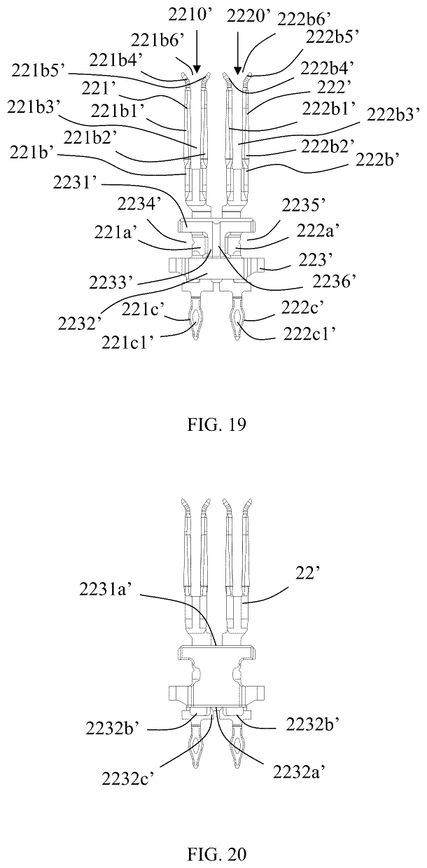

Referring to FIG. 19 and FIG. 20, each terminal module 22′ includes a first signal terminal 221′, a second signal terminal 222′, and an insulating block 223′ fixed to the first signal terminal 221′ and the second signal terminal 222′. In an embodiment of the present disclosure, the first signal terminal 221′ and the second signal terminal 222′ are insert-molded with the insulating block 223′. In an embodiment of the present disclosure, the first signal terminal 221′ and the second signal terminal 222′ form a pair of differential signal terminals. In the illustrated first embodiment of the present disclosure, the first signal terminal 221′ and the second signal terminal 222′ are symmetrically arranged along a central axis of the insulating block 223′.

The first signal terminal 221′ includes a first fixing portion 221a′ fixed to the insulating block 223′, a first contact portion 221b′ extending upwardly from the first fixing portion 221a′, and a first mounting foot 221c′ extending downwardly from the first fixing portion 221a′. The first mounting foot 221c′ has a first fisheye hole 221c1′ so that the first mounting foot 221c′ has a certain elasticity. As a result, it facilitates pressing the first mounting foot 221c′ into the conductive hole of the second circuit board 302′ so as to achieve electrical conduction. The first contact portion 221b′ has a two-half structure and includes a first contact piece 221b1′, a second contact piece 221b2′, and a first insertion hole 2210′ located between the first contact piece 221b1′ and the second contact piece 221b2′. The first contact piece 221b1′ and the second contact piece 221b2′ are separated by two first slots 221b3′, so that the first contact portion 221b′ has better elasticity, thereby improving the reliability of mating with the conductive terminals of a mating connector. In addition, the first contact piece 221b1′ also includes a first flared portion 221b4′ at its end. The second contact piece 221b2′ also includes a second flared portion 221b5′ at its end. The first flared portion 221b4′ and the second flared portion 221b5′ form a first bell mouth 221b6′ communicating with the first insertion hole 2210′ in order to guide the insertion of the conductive terminal of the mating connector.

The second signal terminal 222′ includes a second fixing portion 222a′ fixed to the insulating block 223′, a second contact portion 222b′ extending upwardly from the second fixing portion 222a′, and a second mounting foot 222c′ extending downwardly from the second fixing portion 222a′. The second mounting foot 222c′ has a second fisheye hole 222c1′ so that the second mounting foot 222c′ has a certain elasticity. As a result, it facilitates pressing the second mounting foot 222c′ into the conductive hole of the second circuit board 302′ so as to achieve electrical conduction. The second contact portion 222b′ has a two-half structure and includes a third contact piece 222b1′, a fourth contact piece 222b2′, and a second insertion hole 2220′ located between the third contact piece 222b1′ and the fourth contact piece 222b2′. The third contact piece 222b1′ and the fourth contact piece 222b2′ are separated by two second slots 222b3′, so that the second contact portion 222b′ has better elasticity, thereby improving the reliability of mating with the conductive terminals of a mating connector. In addition, the third contact piece 222b1′ also includes a third flared portion 222b4′ at its end. The fourth contact piece 222b2′ also includes a fourth flared portion 222b5′ at its end. The third flared portion 222b4′ and the fourth flared portion 222b5′ form a second bell mouth 222b6′ communicating with the second insertion hole 2220′ in order to guide the insertion of the conductive terminal of the mating connector.

When the signal terminals of the first backplane connector 100 are separating from the first contact portion 221b′ of the first signal terminal 221′ and the second contact portion 222b′ of the second signal terminal 222′ of the second backplane connector 200′, during the separation process, the signal terminals of the first backplane connector 100 will pass through the first extension block 261′ and the second extension block 262′ from bottom to top along the vertical direction. At this time, the first extension block 261′ and the second extension block 262′ are capable of reducing the degree of change in dielectric constant caused by the air medium surrounding the signal terminal pair, thereby playing a role of adjusting impedance of the signal terminal pair.

In the illustrated first embodiment of the present disclosure, the insulating block 223′ includes a top portion 2231′, a bottom portion 2232′, and a connection portion 2233′ connecting the top portion 2231′ and the bottom portion 2232′. The top portion 2231′ is parallel to the bottom portion 2232′. The connection portion 2233′ is perpendicular to the top portion 2231′ and the bottom portion 2232′. An upper end and a lower end of the connection portion 2233′ is connected to a middle of the top portion 2231′ and a middle of the bottom portion 2232′, respectively. The top portion 2231′ has a top surface 2231a′. The length of the top portion 2231′ is shorter than the length of the bottom portion 2232′. The insulating block 223′ also includes a first opening 2234′ and a second opening 2235′ located between the top portion 2231′ and the bottom portion 2232′. The first opening 2234′ and the second opening 2235′ are respectively located on both sides of the connection portion 2233′. The first fixing portion 221a′ of the first signal terminal 221′ is partially exposed in the first opening 2234′, and the second fixing portion 222a′ of the second signal terminal 222′ is partially exposed in the second opening 2235′ for adjusting impedance. The bottom portion 2232′ includes a bottom surface 2232a′, two protrusions 2232b′ protruding downwardly from the bottom surface 2232a′, and a positioning groove 2232c′ located between the two protrusions 2232b′. The two protrusions 2232b′ respectively abut against the bottom end of the first fixing portion 221a′ and the bottom end of the second fixing portion 222a′. The outer peripheral surface of the insulating block 223′ also includes a plurality of ribs 2236′. The outer surface of the rib 2236′ is in the shape of a semicircular arc. In the illustrated first embodiment of the present disclosure, the rib 2236′ is located in the middle position of the two sides of the top portion 2231′ and in the middle position of the front end surface of the connection portion 2233′. Of course, in other embodiments, the ribs 2236′ can also be arranged on both sides of the bottom portion 2232′ and/or the front end surface of the bottom portion 2232′. The rib 2236′ is used to abut against the insulating body 26′ in order to improve the reliability of installation.

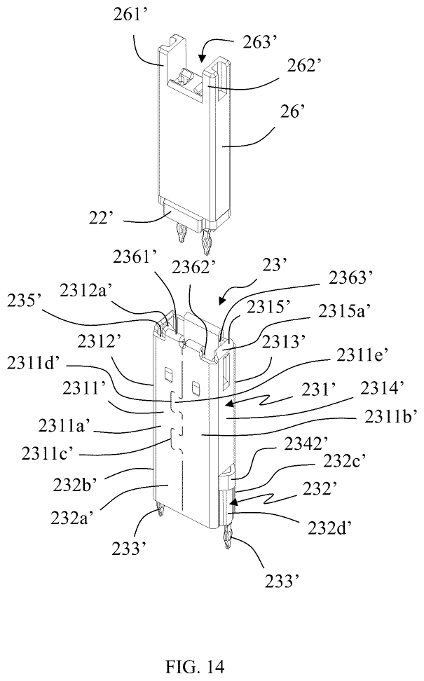

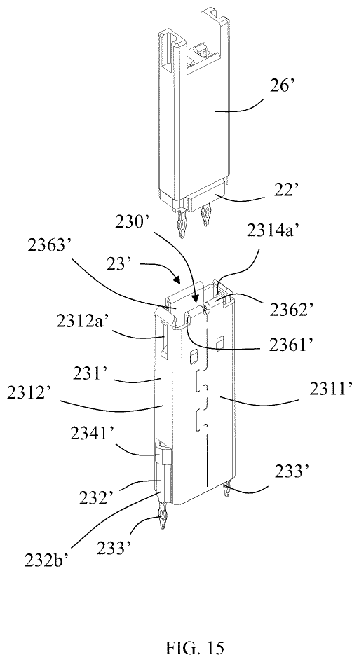

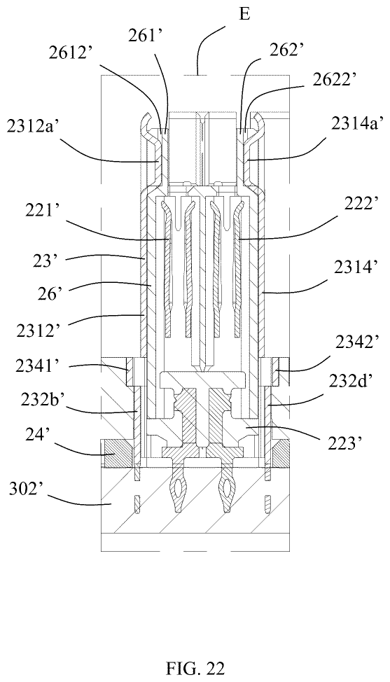

Referring to FIG. 14, FIG. 15 and FIG. 22, in the illustrated first embodiment of the present disclosure, the metal shield surrounding member 23′ is formed by stamping, bending and riveting a metal plate. The metal shield surrounding member 23′ includes a surrounding portion 231′, a mounting portion 232′ extending downwardly from the surrounding portion 231′, a plurality of mounting feet 233′ extending downwardly from the mounting portion 232′, and a positioning protrusion located between the surrounding portion 231′ and the mounting portion 232′. The surrounding portion 231′ includes a first side wall 2311′, a second side wall 2312′, a third side wall 2313′ and a fourth side wall 2314′. The first side wall 2311′ is opposite to the third side wall 2313′, and the second side wall 2312′ is opposite to the fourth side wall 2314′, thereby forming a fully-enclosed shielding cavity. In the first embodiment of the present disclosure, the metal shield surrounding member 23′ includes an inner cavity 230′ enclosed by the first side wall 2311′, the second side wall 2312′, the third side wall 2313′ and the fourth side wall 2314′. In the illustrated first embodiment of the present disclosure, areas of the first side wall 2311′ and the third side wall 2313′ are larger than areas of the second side wall 2312′ and the fourth side wall 2314′. Each end of the second side wall 2312′ and the fourth side wall 2314′ includes a deflection portion 2315′ which is bent inwardly. The deflection portions 2315′ are independent from one another so that they can be bent independently in order to avoid mutual interference. Each deflection portion 2315′ has a guiding portion 2315a′ on its outer surface. In the illustrated first embodiment of the present disclosure, the guiding portion 2315a′ is in an arc shape that is bent inwardly. By providing the deflection portions 2315′, a constricted opening can be formed at the end of the metal shield surrounding member 23′. The guiding portion 2315a′ can guide the deflection portions 2315′ from being easily inserted into the first backplane connector 100. In the illustrated first embodiment of the present disclosure, the first side wall 2311′ includes a first wall portion 2311a′ and a second wall portion 2311b′. The first wall portion 2311a′ and the second wall portion 2311b′ are fixed together by riveting. A riveting line 2311c′ is formed at a junction of the first wall portion 2311a′ and the second wall portion 2311b′. In the first embodiment illustrated in the present disclosure, the first wall portion 2311a′ and the second wall portion 2311b′ are provided with dovetail grooves 2311d′ and dovetail protrusions 2311e′ that are interlocked with each other. In other embodiments of the present disclosure, it is also possible that only the ends of at least three of the first side wall 2311′, the second side wall 2312′, the third side wall 2313′ and the fourth side wall 2314′ which are connected to each other, are provided with the deflection portions 2315′ bent inwardly. For example, the deflection portions 2315′ bent inwardly are provided at the ends of the second side wall 2312′, the third side wall 2313′ and the fourth side wall 2314′ which are sequentially connected.

In the illustrated first embodiment of the present disclosure, the mounting portion 232′ includes a fifth side wall 232a′, a sixth side wall 232b′, a seventh side wall 232c′ and an eighth side wall 232d′. The fifth side wall 232a′ is opposite to the seventh side wall 232c′, and the sixth side wall 232b′ is opposite to the eighth side wall 232d′, so as to form a fully-enclosed shielding cavity. In the illustrated first embodiment of the present disclosure, an area of each of the fifth side wall 232a′ and the seventh side wall 232c′ is larger than an area of each of the sixth side wall 232b′ and the eighth side wall 232d′.

The fifth side wall 232a′ and the first side wall 2311′ are located on a same side of the metal shield surrounding member 23′. The sixth side wall 232b′ and the second side wall 2312′ are located on a same side of the metal shield surrounding member 23′. The seventh side wall 232c′ and the third side wall 2313′ are located on a same side of the metal shield surrounding member 23′. The eighth side wall 232d′ and the fourth side wall 2314′ are located on a same side of the metal shield surrounding member 23′.

In the illustrated first embodiment of the present disclosure, the fifth side wall 232a′ is located in a same plane as the first side wall 2311′, that is, the fifth side wall 232a′ is flush with the first side wall 2311′. The seventh side wall 232c′ is located in a same plane as the third side wall 2313′, that is, the seventh side wall 232c′ is flush with the third side wall 2313′. As shown in FIG. 22, the sixth side wall 232b′ protrudes beyond the second side wall 2312′. The eighth side wall 232d′ protrudes beyond the fourth side wall 2314′. The positioning protrusion includes a first positioning protrusion 2341′ located between the sixth side wall 232b′ and the second side wall 2312′, and a second positioning protrusion 2342′ located between the eighth side wall 232d′ and the fourth side wall 2314′. The first positioning protrusion 2341′ is arc-shaped and protrudes beyond the seventh side wall 232c′ and the third side wall 2313′. The second positioning protrusion 2342′ is arc-shaped and protrudes beyond the eighth side wall 232d′ and the fourth side wall 2314′.

In the illustrated first embodiment of the present disclosure, the second side wall 2312′ further includes a first bulge 2312a′ stamped inwardly and locked in the first positioning groove 2612′. The fourth side wall 2314′ further includes a second bulge 2314a′ stamped inwardly and locked in the second positioning groove 2622′.

The plurality of mounting feet 233′ integrally extend downwardly from the sixth side wall 232b′ and the eighth side wall 232d′, respectively.

Referring to FIG. 14 and FIG. 15, in the illustrated first embodiment of the present disclosure, the surrounding portion 231′ includes a port portion 235′ which is substantially rectangular. The deflection portion 2315′ is bent inwardly from two sides of the port portion 235′. The first wall portion 2311a′ includes a first reflective piece 2361′ that is bent from the port portion 235′ into the inner cavity 230′. The first reflective piece 2361′ at least partially abuts against an inner wall surface of the first wall portion 2311a′. Similarly, the second wall portion 2311b′ includes a second reflective piece 2362′ bent from the port portion 235′ into the inner cavity 230′. The second reflective piece 2362′ at least partially abuts against an inner wall surface of the second wall portion 2311b′. The third side wall 2313′ includes a third reflective piece 2363′ that is bent from the port portion 235′ into the inner cavity 230′. The third reflective piece 2363′ at least partially abuts against an inner wall surface of the third side wall 2313′. A general concept of the first reflective piece 2361′, the second reflective piece 2362′ and the third reflective piece 2363′ is a reflective piece.

In the first embodiment illustrated in the present disclosure, the first reflective piece 2361′ and the second reflective piece 2362′ have the same width along the second direction A2-A2 (for example, a left-right direction). The first reflective piece 2361′ and the second reflective piece 2362′ have the same length along the first direction A1-A1 (for example, a top-bottom direction). A width of the third reflective piece 2363′ along the second direction A2-A2 is greater than the width of the first reflective piece 2361′ and is also greater than the width of the second reflective piece 2362′. A length of the third reflective piece 2363′ along the first direction A1-A1 is equal to the length of the first reflective piece 2361′ and is also equal to the length of the second reflective piece 2362′. In the first embodiment illustrated in the present disclosure, each two of the first direction A1-A1, the second direction A2-A2, and the third direction A3-A3 are perpendicular to each other. The reflective piece does not overlap the first contact portion 221b′ and the second contact portion 222b′ along the first direction A1-A1.

Compared with the prior art, the present disclosure is able to adjust the impedance of the signal terminals to a certain extent by providing the first reflection piece 2361′, the second reflection piece 2362′ and the third reflection piece 2363′. Therefore, when the first backplane connector 100 and the second backplane connector 200′ change from the mating state to the separation state, the impedance change of the signal terminals is suppressed as much as possible, so that the impedance of the signal terminals is kept stable.

Referring to FIG. 11, the mounting block 24′ includes a plurality of mounting portions 232′ configured to position and limit the metal shield surrounding member 23′. Specifically, the mounting block 24′ includes a plurality of mounting bars 241′ arranged in a staggered manner and connected as a whole. Each mounting bar 241′ includes a positioning slot 242′ for positioning the mounting portion 232′.

When assembling, the terminal module 22′ and the insulating body 26′ are assembled together firstly. The insulating block 223′ is at least partially accommodated in the accommodating space 2603′. Then, the metal shield surrounding member 23′ is sleeved on the insulating body 26′ so as to form the mounting module 25′. Then, the mounting module 25′ are assembled in a corresponding receiving groove 2108′ of the housing 21′ from top to bottom. The mounting portion 232′ is locked in the main groove 2108a′. The four arc-shaped corners of the mounting portion 232′ correspond to the first arc-shaped surface 2108a1′, the second arc-shaped surface 2108a2′, the third arc-shaped surface 2108a3′ and the fourth arc-shaped surface 2108a4′, so as to balance the force distribution and avoid installation inclination. The first positioning protrusion 2341′ and the second positioning protrusion 2342′ are locked in the first groove 2108b′ and the second groove 2108c′, respectively. The first positioning protrusion 2341′ and the second positioning protrusion 2342′ abut against the first support surface 2108b1′ and the second support surface 2108c1′, respectively, so as to function as positioning and limiting. Finally, the mounting block 24′ is installed in the receiving groove 2100′ from bottom to top, so as to fix the mounting portion 232′ of the metal shield surrounding member 23′. At this time, the mounting feet 233′ of the metal shield surrounding member 23′, the first mounting foot 221c′ of the first signal terminal 221′, and the second mounting foot 222c′ of the second signal terminal 222′ pass through the mounting block 24′ to be electrically connected to the second circuit board 302′.

When the first backplane connector 100 is mated with the second backplane connector 200′, the first housing 1 of the first backplane connector 100 is at least partially inserted into the receiving space 213′ of the housing 21′ of the second backplane connector 200′. The surrounding portions 231′ of the terminal modules 22′ of the second backplane connector 200′ are inserted into the first terminal modules 2 of the first backplane connector 100 under the guidance of the deflection portions 2315′.

In the illustrated first embodiment of the present disclosure, the metal shield surrounding member 23′ of the present disclosure includes a surrounding portion 231′ and a mounting portion 232′ extending downwardly from the surrounding portion 231′. Both the surrounding portion 231′ and the mounting portion 232′ are formed by four side walls so as to form a fully-enclosed shielding cavity, thereby improving the shielding effect. In addition, the fifth side wall 232a′ is connected to the first side wall 2311′ and is located on the same side of the metal shield surrounding member 23′. The sixth side wall 232b′ is connected to the second side wall 2312′ and is located on the same side of the metal shield surrounding member 23′. The seventh side wall 232c′ is connected to the third side wall 2313′ and is located on the same side of the metal shield surrounding member 23′. The eighth side wall 232d′ is connected to the fourth side wall 2314′ and is located on the same side of the metal shield surrounding member 23′. In this way, the fifth side wall 232a′ and the first side wall 2311′ are able to form a grounding return; the sixth side wall 232b′ and the second side wall 2312′ are able to form a grounding return; the seventh side wall 232c′ and the third side wall 2313′ are able to form a grounding return; and the eighth side wall 232d′ and the fourth side wall 2314′ are able to form a grounding return; thereby improving the effect of the grounding return.

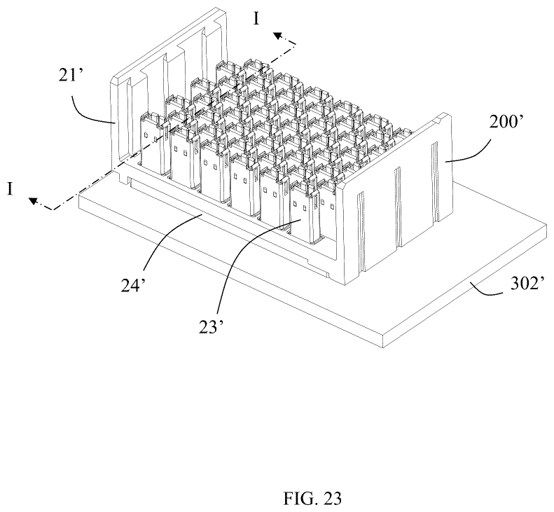

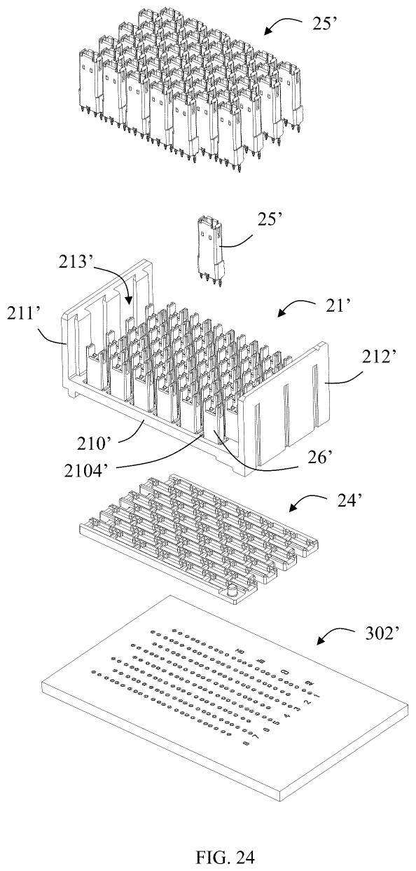

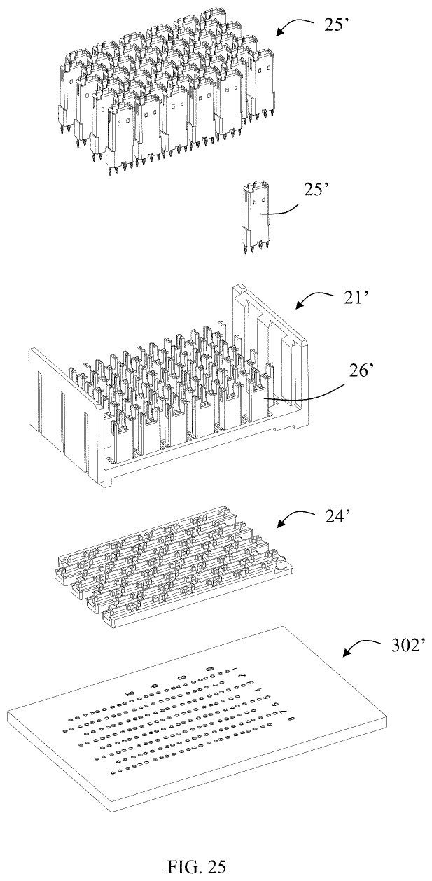

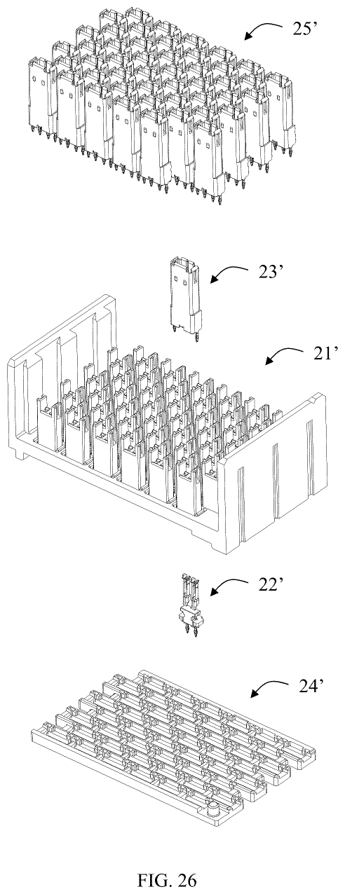

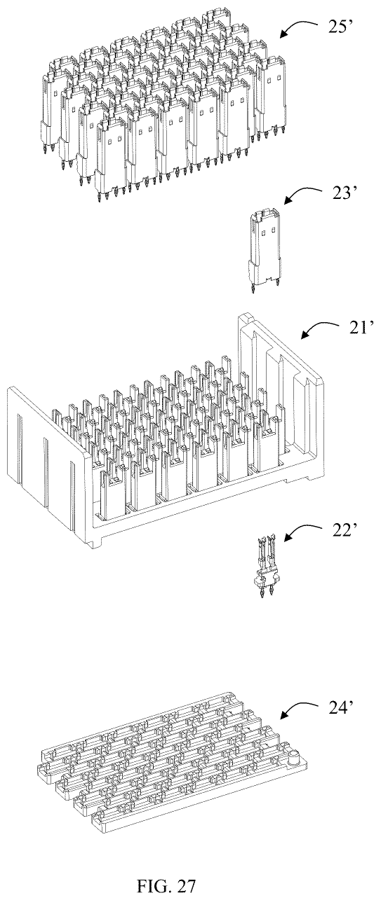

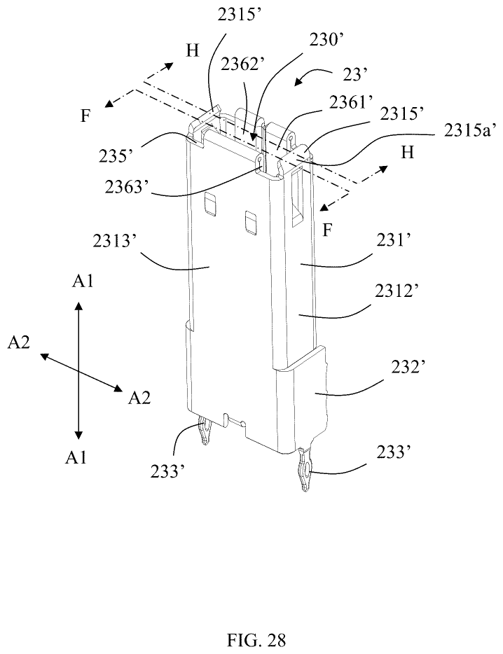

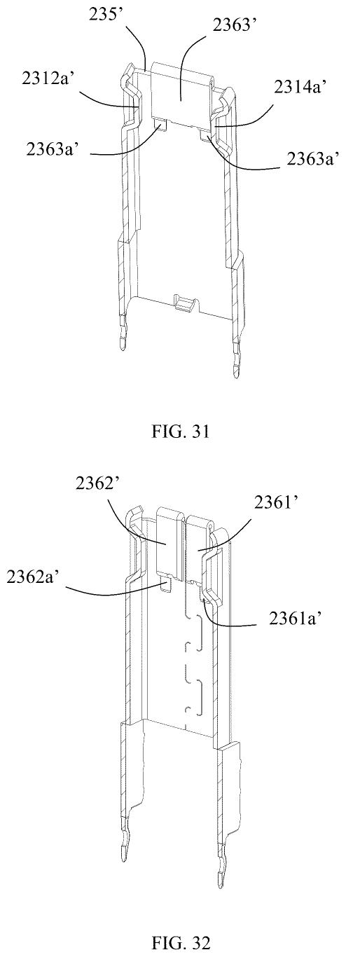

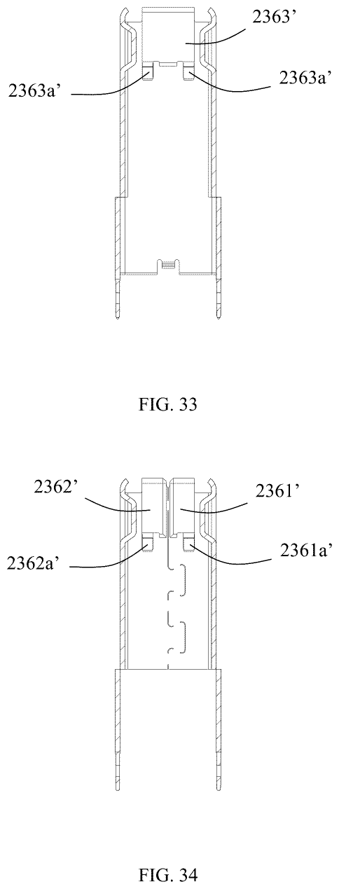

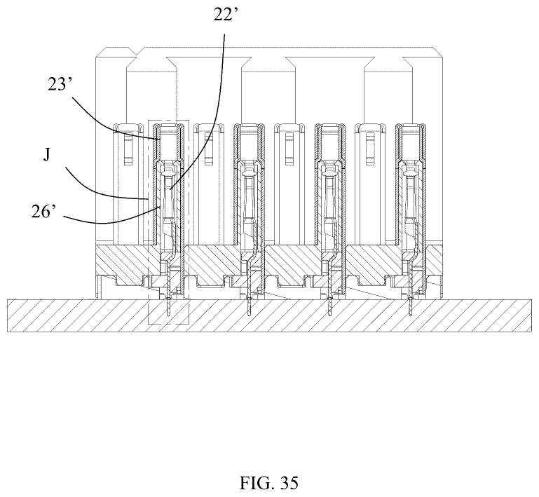

Referring to FIG. 23 to FIG. 36, in a second embodiment of the second backplane connector 200′ of the present disclosure, the second backplane connector 200′ includes a housing 21′, a plurality of terminal modules 22′ mounted to the housing 21′, a mounting block 24′ mounted to the housing 21′, and a plurality of metal shield surrounding members 23′ sleeved on the insulating bodies 26′. The second backplane connector 200′ is configured to be mounted to the second circuit board 302′. When assembling the second backplane connector 200′, the terminal modules 22′ and the metal shield surrounding members 23′ are assembled to the housing 21′ along opposite directions. For example, the terminal modules 22′ are assembled on the housing 21′ from bottom to top. The metal shield surrounding members 23′ are assembled to the housing 21′ from top to bottom.

The main difference between the second backplane connector 200′ in the second embodiment of the present disclosure and the second backplane connector 200′ in the first embodiment of the present disclosure is that, in the second backplane connector 200′ in the second embodiment of the present disclosure, the plurality of insulating bodies 26′ are integrally formed with the base 210′ of the housing 21′. In addition, in the second backplane connector 200′ in the second embodiment of the present disclosure, there are some structural differences between the metal shield surrounding member 23′ in the second embodiment compared to the metal shield surrounding member 23′ in the first embodiment. The following will describe the main differences between the second backplane connector 200′ in the second embodiment of the present disclosure and the second backplane connector 200′ in the first embodiment of the present disclosure. For the same or corresponding parts, please refer to the relevant descriptions in the first embodiment of the present disclosure.

In the second embodiment of the second backplane connector 200′ of the present disclosure, the base 210′ is provided with a plurality of positioning grooves 2104′. Each positioning groove 2104′ is located outside a corresponding insulating body 26′. The positioning groove 2104′ is of a U-shaped configuration.

In the second embodiment of the second backplane connector 200′ of the present disclosure, the metal shield surrounding member 23′ is assembled on the housing 21′ and sleeved on the corresponding insulating body 26′.

Referring to FIGS. 23 to 36, in the second embodiment of the present disclosure, the metal shield surrounding member 23′ is formed by stamping, bending and riveting a metal plate. The metal shield surrounding member 23′ includes a surrounding portion 231′, a mounting portion 232′ extending downwardly from the surrounding portion 231′, and a plurality of mounting feet 233′ extending downwardly from the mounting portion 232′. The surrounding portion 231′ includes a first side wall 2311′, a second side wall 2312′, a third side wall 2313′ and a fourth side wall 2314′ connected in sequence. The first side wall 2311′ is opposite to the third side wall 2313′. The second side wall 2312′ is opposite to the fourth side wall 2314′. A fully-enclosed shielding cavity is formed by the first side wall 2311′, the second side wall 2312′, the third side wall 2313′ and the fourth side wall 2314′. In the second embodiment of the present disclosure, the metal shield surrounding member 23′ includes an inner cavity 230′ enclosed by the first side wall 2311′, the second side wall 2312′, the third side wall 2313′ and the fourth side wall 2314′. In the second embodiment of the present disclosure, the areas of the first side wall 2311′ and the third side wall 2313′ are larger than those of the second side wall 2312′ and the fourth side wall 2314′. In the second embodiment of the present disclosure, each end of the second side wall 2312′ and the fourth side wall 2314′ is provided with a deflection portion 2315′ bent inwardly. The deflection portions 2315′ are independent from one another so that they can be bent independently in order to avoid mutual interference. Each deflection portion 2315′ is provided with a guiding portion 2315a′ located on an outer surface thereof. In the second embodiment of the present disclosure, the guiding portion 2315a′ is in an arc shape that is bent inwardly. By providing the deflection portions 2315′, a constricted opening can be formed at the end of the metal shield surrounding member 23′. The guiding portion 2315a′ can guide the deflection portions 2315′ from being easily inserted into the first backplane connector 100. In the second embodiment of the present disclosure, the first side wall 2311′ includes a first wall portion 2311a′ and a second wall portion 2311b′. The first wall portion 2311a′ and the second wall portion 2311b′ are fixed together by riveting. A rivet line 2311c′ is formed at a joint between the first wall portion 2311a′ and the second wall portion 2311b′. In the second embodiment illustrated in the present disclosure, the first wall portion 2311a′ and the second wall portion 2311b′ are provided with dovetail grooves 2311d′ and dovetail protrusions 2311e′ that are interlocked with each other. In other embodiments of the present disclosure, the deflection portions 2315′ bent inwardly can be provided on at least three connected ends of the first side wall 2311′, the second side wall 2312′, the third side wall 2313′ and the fourth side wall 2314′. For example, the deflection portions 2315′ bent inwardly are provided at the ends of the second side wall 2312′, the third side wall 2313′ and the fourth side wall 2314′ which are connected in sequence.

In the second embodiment of the present disclosure, the mounting portion 232′ is of a U-shaped configuration. The mounting portion 232′ includes a connecting portion 2320′, a first bending portion 2321′ bent from a side of the connecting portion 2320′, and a second bending portion 2322′ bent from an opposite side of the connecting portion 2320′. The mounting portion 232′ is assembled and fixed in the positioning groove 2104′.

In the second embodiment of the present disclosure, the surrounding portion 231′ includes a port portion 235′ which is substantially rectangular. The deflection portions 2315′ are bent inwardly from two sides of the port portion 235′. The first wall portion 2311a′ includes a first reflective piece 2361′ that is bent from the port portion 235′ into the inner cavity 230′. The first reflective piece 2361′ abuts against an inner wall surface of the first wall portion 2311a′. Similarly, the second wall portion 2311b′ includes a second reflective piece 2362′ bent from the port portion 235′ into the inner cavity 230′. The second reflective piece 2362′ abuts against an inner wall surface of the second wall portion 2311b′. The third side wall 2313′ includes a third reflective piece 2363′ that is bent from the port portion 235′ into the inner cavity 230′. The third reflective piece 2363′ abuts against an inner wall surface of the third side wall 2313′. In the second embodiment illustrated in the present disclosure, the first reflective piece 2361′ and the second reflective piece 2362′ have the same width along the second direction A2-A2 (for example, the left-right direction). The first reflective piece 2361′ and the second reflective piece 2362′ have the same length along the first direction A1-A1 (for example, the top-bottom direction). A width of the third reflective piece 2363′ along the second direction A2-A2 is greater than the width of the first reflective piece 2361′ and is also greater than the width of the second reflective piece 2362′. A length of the third reflective piece 2363′ along the first direction A1-A1 is equal to the length of the first reflective piece 2361′ and is also equal to the length of the second reflective piece 2362′. In one embodiment of the present disclosure, the first reflective piece 2361′, the second reflective piece 2362′, and the third reflective piece 2363′ all at least partially protrude into the accommodating space 263′ of the insulating body 26′.

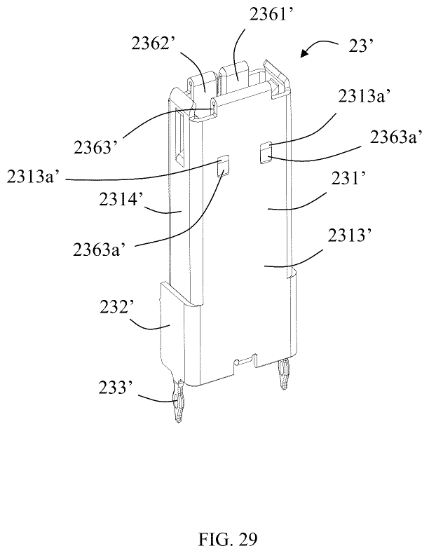

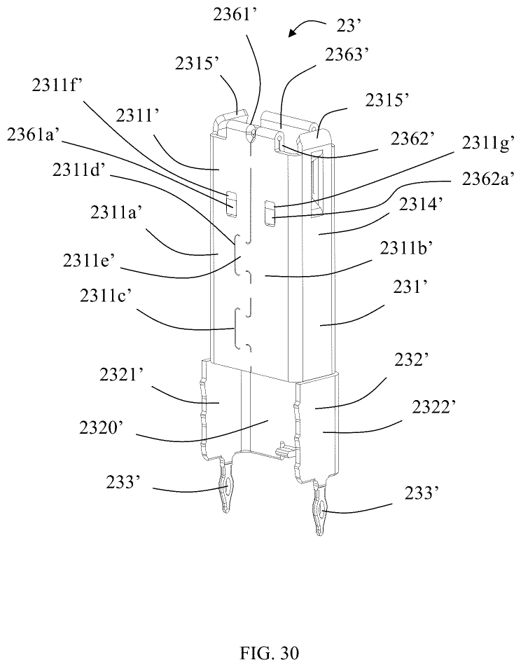

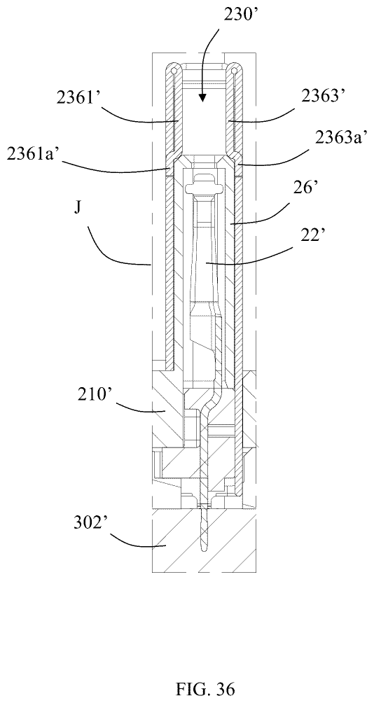

Referring to FIG. 29, FIG. 30 and FIG. 36, in the illustrated embodiment of the present disclosure, the first wall portion 2311a′ of the first side wall 2311′ further defines a first opening 2311f that extends through the first wall portion 2311a′ and communicates with the inner cavity 230′. The second wall portion 2311b′ of the first side wall 2311′ further defines a second opening 2311g′ that extends through the second wall portion 2311b′ and communicates with the inner cavity 230′. The third side wall 2313′ further defines a plurality of third openings 2313a′ that extend through the third side wall 2313′ and communicate with the inner cavity 230′. The first reflective piece 2361′ is provided with a first deflection tab 2361a′ located at a free end thereof. The first deflection tab 2361a′ is at least partially received in the first opening 2311f′ to fill the first opening 2311f′, thereby improving the shielding effect. The second reflective piece 2362′ is provided with a second deflection tab 2362a′ located at a free end thereof. The second deflection tab 2362a′ is at least partially received in the second opening 2311g′ to fill the second opening 2311g′, thereby improving the shielding effect. The third reflective piece 2363′ is provided with a plurality of third deflection portions 2363a′ located at a free end thereof. The third deflection tabs 2363a′ are at least partially received in the plurality of third openings 2313a′ to fill the third openings 2313a′, thereby improving the shielding effect. In the illustrated embodiment of the present disclosure, an outer surface of the first deflection tab 2361a′ is coplanar with an outer surface of the first wall portion 2311a′. An outer surface of the second deflection tab 2362a′ is coplanar with an outer surface of the second wall portion 2311b′. An outer surface of the third deflection tab 2363a′ is coplanar with an outer surface of the third side wall 2313′.

Compared with the prior art, the present disclosure is capable of adjusting the impedance of the signal terminals to a certain extent by providing the first reflection piece 2361′, the second reflection piece 2362′ and the third reflection piece 2363′. When the first backplane connector 100 and the second backplane connector 200′ change from the mating state to the separation state, the impedance change of the signal terminals is suppressed as much as possible, so that the impedance of the signal terminals is kept stable.

The above embodiments are only used to illustrate the present disclosure and not to limit the technical solutions described in the present disclosure. The understanding of this specification should be based on those skilled in the art. Descriptions of directions, such as “front”, “rear”, “left”, “right”, “top” and “bottom”, although they have been described in detail in the above-mentioned embodiments of the present disclosure, those skilled in the art should understand that modifications or equivalent substitutions can still be made to the application, and all technical solutions and improvements that do not depart from the spirit and scope of the application should be covered by the claims of the application.

What is claimed is:

1. A backplane connector, comprising:
a housing comprising a base, a first side wall portion extending from one end of the base, and a second side wall portion extending from another end of the base; the base, the first side wall portion and the second side wall portion jointly forming a receiving space for at least partially receiving a mating connector;
an insulating body, the insulating body defining at least one terminal receiving hole;
a terminal module, the terminal module comprising a first signal terminal and a second signal terminal; the first signal terminal and the second signal terminal being at least partially disposed in the at least one terminal receiving hole; and
a metal shield surrounding member, the metal shield surrounding member being sleeved on the insulating body;
wherein the metal shield surrounding member comprises a surrounding portion protruding into the receiving space; the surrounding portion comprises a first side wall, a second side wall, a third side wall and a fourth side wall; the first side wall is disposed opposite to the third side wall; the second side wall is disposed opposite to the fourth side wall; the first side wall, the second side wall, the third side wall and the fourth side wall are enclosed to form an inner cavity; and
wherein the surrounding portion comprises a port portion and at least one reflective piece which is bent from the port portion; the at least one reflective piece extends at least partially into the inner cavity along a first direction.

2. The backplane connector according to claim 1, wherein the at least one reflective piece comprises a first reflective piece and a second reflective piece which are provided on the first side wall; both the first reflective piece and the second reflective piece at least partially abut against an inner wall surface of the first side wall.

3. The backplane connector according claim 2, wherein the at least one reflective piece comprises a third reflective piece provided on the third side wall; the third reflective piece at least partially abuts against an inner wall surface of the third side wall.

4. The backplane connector according to claim 3, wherein the first side wall comprises a first wall portion and a second wall portion; the first wall portion and the second wall portion are fixed together by riveting; a riveting line is formed at a joint between the first wall portion and the second wall portion;
the first reflective piece is provided on the first wall portion; the second reflective piece is provided on the second wall portion.

5. The backplane connector according to claim 4, wherein a width of the third reflective piece along a second direction is greater than a width of the first reflective piece along the second direction; the width of the third reflective piece along the second direction is also greater than a width of the second reflective piece along the second direction; the second direction is perpendicular to the first direction.

6. The backplane connector according to claim 5, wherein the width of the first reflective piece along the second direction is the same as the width of the second reflective piece along the second direction;
a length of the first reflective piece along the first direction, a length of the second reflective piece along the first direction, and a length of the third reflective piece along the first direction are the same.

7. The backplane connector according to claim 1, wherein the base defines a receiving groove extending through the base;
the backplane connector comprises a mounting module assembled to the receiving groove; the mounting module comprises the insulating body, the terminal module and the metal shield surrounding member; the insulating body and the housing are provided separately.

8. The backplane connector according to claim 7, wherein the metal shield surrounding member comprises a mounting portion integrally extending from the surrounding portion; the mounting portion comprises a fifth side wall, a sixth side wall, a seventh side wall and an eighth side wall; the fifth side wall is disposed opposite to the seventh side wall; the sixth side wall is disposed opposite to the eighth side wall; the fifth side wall, the sixth side wall, the seventh side wall and the eighth side wall are enclosed to form a fully-enclosed shielding cavity;
the fifth side wall is connected to the first side wall and is located on a same side of the metal shield surrounding member; the sixth side wall is connected to the second side wall and is located on a same side of the metal shield surrounding member; the seventh side wall is connected to the third side wall and is located on a same side of the metal shield surrounding member; the eighth side wall is connected to the fourth side wall and is located on a same side of the metal shield surrounding member; and
the mounting portion is fixed in the receiving groove.

9. The backplane connector according to claim 8, wherein the sixth side wall protrudes outwardly beyond the second side wall; and the eighth side wall protrudes outwardly beyond the fourth side wall.

10. The backplane connector according to claim 9, wherein the fifth side wall is flush with the first side wall; and the seventh side wall is flush with the third side wall.

11. The backplane connector according to claim 9, wherein the metal shield surrounding member comprises a first positioning protrusion located between the sixth side wall and the second side wall, and a second positioning protrusion located between the eighth side wall and the fourth side wall;
the receiving groove comprises a main groove located in the middle, a first groove located on one side of the main groove, and a second groove located on another side of the main groove; the mounting portion is fixed in the main groove; the first positioning protrusion is fixed in the first groove; the second positioning protrusion is fixed in the second groove.

12. The backplane connector according to claim 11, wherein the first groove is an arc-shaped groove and is recessed in a direction away from the second groove; the second groove is an arc-shaped groove and is recessed in a direction away from the first groove; the base comprises a first support surface located at a bottom of the first groove, and a second support surface located at a bottom of the second groove;
the first positioning protrusion abuts against the first support surface; the second positioning protrusion abuts against the second support surface.

13. The backplane connector according to claim 11, wherein the main groove comprises a first arc-shaped surface, a second arc-shaped surface, a third arc-shaped surface and a fourth arc-shaped surface which are located at four corners of the main groove; the first groove is located in a middle of the first arc-shaped surface and the third arc-shaped surface; and the second groove is located in a middle of the second arc-shaped surface and the fourth arc-shaped surface.

14. The backplane connector according to claim 8, wherein the metal shield surrounding member further comprises a plurality of mounting feet extending from the mounting portion; the backplane connector further comprises a mounting block mounted to a bottom of the housing;
the mounting block defines a positioning slot to position the mounting portion; the plurality of mounting feet pass through the mounting block.

15. The backplane connector according to claim 8, wherein the terminal module comprises an insulating block fixed on the first signal terminal and the second signal terminal;
the insulating body comprises a base portion, a first extension block extending upwardly from one side of the base portion, and a second extension block extending upwardly from another side of the base portion; the base portion defines a first terminal receiving hole and a second terminal receiving hole; the at least one terminal receiving hole comprising the first terminal receiving hole and the second terminal receiving hole; the first signal terminal and the second signal terminal are accommodated in the first terminal receiving hole and the second terminal receiving hole, respectively;
the first extension block comprises a first side surface and a first positioning groove recessed inwardly from the first side surface; the second extension block comprises a second side surface and a second positioning groove recessed inwardly from the second side surface;
the third side wall comprises a first bulge protruding inwardly to be locked in the first positioning groove; the fourth side wall comprises a second bulge protruding inward to be locked in the second positioning groove.

16. The backplane connector according to claim 15, wherein the first positioning groove does not extend inwardly through the first extension block; and the second positioning groove does not extend inwardly through the second extension block.

17. The backplane connector according to claim 15, wherein the first positioning groove extends upwardly through a top surface of the first extension block; and the second positioning groove extends upwardly through a top surface of the second extension block.

18. The backplane connector according to claim 1, wherein the insulating body and the base are integrally formed; the base defines a positioning groove located outside the insulating body; the positioning groove is of a U-shaped configuration;
the metal shield surrounding member is assembled to the housing; the metal shield surrounding member comprises a mounting portion extending downwardly from the surrounding portion; the mounting portion is of a U-shaped configuration; the mounting portion comprises a connecting portion, a first bending portion bent from a side of the connecting portion and a second bending portion bent from an opposite side of the connecting portion; the mounting portion is assembled and fixed in the positioning groove.

19. The backplane connector according to claim 2, wherein the first side wall defines a first opening extending through the first side wall; the first reflective piece is provided with a first deflection tab located at a free end thereof; the first deflection tab is at least partially received in the first opening.

20. The backplane connector according to claim 15, wherein the base portion comprises an upper surface and a lower surface; both the first terminal receiving hole and the second terminal receiving hole extend through the upper surface; both the first extension block and the second extension block extend upwardly beyond the upper surface.
